(19) United States
(12) Patent Application Publication
(10) Pub. No.: US 2026/0064738 A1
(43) Pub. Date: Mar. 5, 2026

(54) SYSTEM AND METHOD FOR IDENTIFYING DATA SOURCES FOR GENERATIVE ARTIFICIAL INTELLIGENCE

(71) Applicant: True Elements, Inc., Naples, FL (US)

(72) Inventors: David BANKSTON, Naples, FL (US); William C. LOUISELL, III, Bainbridge Island, WA (US); Varun KUMAR, Avon Lake, OH (US)

(21) Appl. No.: 19/311,871

(22) Filed: Aug. 27, 2025

Related U.S. Application Data
(60) Provisional application No. 63/688,110, filed on Aug. 28, 2024.

(51) Int. Cl. G06F 16/334; G06F 40/205

(52) U.S. Cl. CPC G06F 16/334; G06F 40/205

(57) ABSTRACT

Systems, methods, and computer-readable storage media for identifying databases or resources which contain verifiable information used to create generative AI output. A system can receive a request for generation of a report, the request including a string of text. The system can then parse the string, resulting in a parsed request, and identify at least one verified data source for each piece of data within the parsed request. The system can then generate a query for each verified data source based on the parsed request, resulting in at least one query, and send those queries to the verified data sources. Those sources can respond with verified data, and the system can generate, using a generative Artificial Intelligence (AI) algorithm, the report using the verified data.

### PRIORITY

This application claims priority to U.S. provisional patent application 63/688,110, filed Aug. 28, 2024, the contents of which are incorporated herein in their entirety.

### BACKGROUND

### 1. Technical Field

The present disclosure relates to reducing hallucinations with generative Artificial Intelligence (AI), and more specifically to identifying what database or resource contains verifiable information used to create generative AI output.

### 2. Introduction

Generative AI refers to using AI to create new content, such as videos, text, images, music, audio, reports, etc. Generative AI uses generative models, in response to prompts, to learn patterns and structures of their training data, then generate new data (i.e., the output) that has similar patterns/structures as the training data. However, generative AI may struggle to accurately understand real-world knowledge, physical properties, math, or factual information. This lack of grounding can result in outputs (aka “hallucinations”) that, while seemingly plausible, are actually made-up, factually incorrect, irrelevant, and/or nonsensical.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a request for generation of a report, the request comprising a string of text; parsing, via at least one processor of the computer system, the string, resulting in a parsed request; identifying, via the at least one processor, at least one verified data source for each piece of data within the parsed request; generating, via the at least one processor, a query for each verified data source based on the parsed request, resulting in at least one query; transmitting, from the computer system to the at least one verified data source, the at least one query; receiving, at the computer system from the at least one verified data source, verified data in response to the at least one query; and generating, via the at least one processor executing a generative Artificial Intelligence (AI) algorithm, the report using the verified data.

A system configured to perform the concepts disclosed herein can include: at least one processor; and a non-transitory computer-readable storage medium having instructions stored which, when executed by the at least one processor, cause the at least one processor to perform operations comprising: receiving a request for generation of a report, the request comprising a string of text; parsing the string, resulting in a parsed request; identifying at least one verified data source for each piece of data within the parsed request; generating a query for each verified data source based on the parsed request, resulting in at least one query; transmitting to the at least one verified data source the at least one query; receiving, from the at least one verified data source, verified data in response to the at least one query; and generating, by executing a generative Artificial Intelligence (AI) algorithm, the report using the verified data.

A non-transitory computer-readable storage medium configured as disclosed herein can have instructions stored which, when executed by at least one processor, cause the at least one processor to perform operations which include: receiving a request for generation of a report, the request comprising a string of text; parsing the string, resulting in a parsed request; identifying at least one verified data source for each piece of data within the parsed request; generating a query for each verified data source based on the parsed request, resulting in at least one query; transmitting to the at least one verified data source the at least one query; receiving, from the at least one verified data source, verified data in response to the at least one query; and generating, by executing a generative Artificial Intelligence (AI) algorithm, the report using the verified data.

### BRIEF DESCRIPTION OF THE DRAWINGS

FIG. 1 illustrates an example system embodiment;

FIG. 2 illustrates an example of parsing a query;

FIG. 3 illustrates a second example system embodiment;

FIG. 4 illustrates an example method embodiment; and

FIG. 5 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

As discussed above, hallucinations with generative AI are a significant issue. Systems configured as disclosed herein can reduce, if not remove, hallucinations from the generative AI output. This is accomplished by the system parsing the query/prompt entered, identifying verified sources of information to be used to answer the query/prompt, and using those verified sources in generating the response to the query/prompt. The resulting response, which was generated using verified sources, can then be provided to the user along with citations to the verified sources.

Consider the following example. At present, trying to understand water quality, composition, and associated dynamics requires access to multiple databases, documents and presentations. A user trying to read through all of those databases, documents, and presentations to generate a report regarding the water quality for a given area would require vast amounts of time to generate the report. A traditional generative AI system, trained on those multiple databases, documents, and presentations, could do the work much faster—but at the risk of the report containing information which seems correct (based on the patterns the system identified in the training data), but which is in fact fabricated data.

By contrast, systems configured as disclosed herein can (1) identify verified data sources required for the report; (2) retrieve the requisite data from those verified data sources; and (3) use generative AI in combination with the retrieved data to generate the report, which may include citations to the verified data sources. In this manner, the system can leverage the power of generative AI to increase the speed of the query/report process, while also minimizing the risk of inaccurate/fabricated data being included in the system's response.

To identify the verified data sources required for a response to a query, the system receives the query, parses the query, classifies the parsed elements of the query, and based on those classifications identifies what type of resource/database would be able to answer that part of the query. The query is preferably text-based, though may be an audible (e.g., speech/voice generated) query which is then converted via speech processing to text (through any acceptable speech-to-text transcription process). Non-limiting examples of the resources identified by the system may include a math “scratchpad” capable of performing arithmetic or other calculations, unstructured documents, public/private databases, graphical data, etc.

Named Entity Recognition (NER) can be utilized as part of the parsing/classification process. NER can be broken down into the following steps:

### 1. Text Preprocessing

Tokenization: The text is split into tokens (words, punctuation marks, etc.).
Normalization: The text is converted into a standard format, which may include
lowercasing, stemming, or lemmatization.

### 2. Feature Extraction

Contextual Features: These include words surrounding the token, which provide context.
Lexical Features: These include the actual word, prefixes, suffixes, capitalization, part-of-speech tags, etc.
Semantic Features: These include information from external knowledge bases like WordNet or domain-specific ontologies.

As will be further escribed below, the system can use a specific model to determine which type of expert algorithm is most appropriate based on the contextual, lexical, and/or semantic features detected. Unlike systems which may not condense or otherwise reduce the amount of data which needs to be input into the model, the systems and methods described herein condense the information in a particular way which reduces the data needed by the model to identify the correct expert algorithm. For example, the system can condense the parsed query into a reduced representation by: Filtering non-salient or redundant data elements; Summarizing entities, attributes, and/or relationships into compact structures; Encoding the resulting information in a form optimized for comparison across candidate expert algorithms (e.g., vectors, tag sets, or weighted features); and/or adapting the condensation process based on the type of query and the expert algorithm being sought. In this manner, the system can reduce the dimensionality of the input data while retaining decision-critical information, thereby enabling efficient and accurate expert algorithm selection.

### 3. Model Explanation

The system can utilize a pre-trained transformer which has been trained to perform this NER task (Similar to a Bidirectional Encoder Representation from Transformers (BERT)). The training of the model can be performed according to methods known to those of skill in the art.

Preferably, the system does not use a rigid rules-based system (which would be too rigid to perform well). Instead, the system uses a deep learning approach to stochastically identify the correct set of tokens that accurately locate and classify named entities mentioned in unstructured text (e.g., the user query) into predefined categories such as persons, organizations, locations, dates, quantities, percentages, etc.

In some cases, the process of identifying resources/databases may be iterative and/or recursive. For example, the initial parsing of a query/prompt may break the question down into multiple pieces, each of which results in the system identifying specific pieces of information which need to be retrieved. Upon retrieving those pieces of information, the system may consider the combined results and determine that an additional database/resource should be retrieved, at which point the system can generate an additional “fetch” request for the data, send that request to the additional database/request, and receive the additional data. This process can continue until the system determines that it has the required data to provide a response to the query/prompt. The system can confirm that an output/response has been obtained, and verify that the data type of that response matches that which is expected. For example, dates can follow a YYYY-MM-DD format. When the data type of the response matches that which is expected, the response type can be identified as matching a desired/predetermined level of accuracy, and can allow the system to complete the answer/report. When the data type does not match, the system can repeat the process of processing the query and/or the data received to that point, generate additional queries, and receive additional data, until the data type of information received matches that which was sought for.

For some queries, the answers may not be satisfactorily provided in text. In such cases, the system may provide a report combining text (generated using generative AI) with data acquired from verifiable resources. For example, if an individual provides a query “What was the air quality of Washington D.C. Jul. 4, 2024?”, the system may parse this query into (1) a report type, (2) a location, (3) a start date, and (4) an end date. The system can then use a natural language entity extractor once a deep learning model has tagged the entities within the query. At that point, the system can use the parsed data to look up the information. In this case, the system can determine the primary and secondary report types through contextual/semantic analysis (as further described below). In the example given, the primary type can be classified as “report-builder,” and a secondary type can be classified as “What's in the air?” Primary categories can, for example, include: State-Experts, Structured Query Language (SQL) Database (DB), Report Builder, and Other. Non-limiting examples of secondary categories for the State-Expert primary category can include a respective state (or province, depending on the country being analyzed). Non-limiting examples of secondary categories for the Report Builder primary category can include reports on impaired water layers, surface and groundwater quality, water conflicts, water Hydrological Unit Codes (HUCs), aqueduct water risk, climate vulnerability index, excess rainfall potential forecasts, polluter information, historical fire data, weather forecast information, water quality data, and/or toxic materials release information. A non-limiting example of a secondary category for the Other primary classification can include a chat. Based on the parameters of a given report, the system can extract relevant text entities such as location, start date, end date, etc. from the query. For instance, an example “What's in my drinking water report” can have the following parameters:

“city”: {“type”: “string”},
“huc”: {“type”: “integer”},
“report_start_date”: {“type”: “string”}, # Date format as string
“report_end_date”: {“type”: “string”}, # Date format as string
“data_rich”: {“type”: “boolean”}, # Report type

Likewise, an example “Discharge monitoring report” can have the following parameters:

“city”: {“type”: “string”},
“huc”: {“type”: “integer”},
“years_selected”: {“type”: “string ”}, # Date format as string
“Pollutants”: {“type”: “string”}, # Pollutants as string

This extraction process can be dynamic, changing what information is extracted depending on the type of report being generated.

The LLM (Large Language Model) used by the system has been trained (i.e., the weights of a base model have been changed), prompt tuned (i.e., systematically improved by exposing the LLM to many (e.g., hundreds or more) iterations, and guard railed (i.e., after the model generates an output, it is compared against a list of predefined categories to ensure it matches exactly with one of those categories). Classification of primary and secondary report types by the system can rely on use of that particularly trained LLM, with the system (1) classifying a query to return a primary and secondary category, and (2) if the primary type identified is a “Report Builder”, the system extracts relevant entities from the query (e.g., location, time frame, and/or specific focus). In steps one and two (which can be LLM-dependent steps), there can be distinct weights, prompts, and/or guardrails. Consider the following example of a query: “Please generate a “what's in my drinking water” report for NYC from January 2018 to February 2018″. The system then performs the following steps:

1) Tokenization: First, the system (via the model) first performs an input breakdown (aka, parsing the input/query), tokenizing the input query into smaller units (tokens), such as individual words and/or subwords. For example, the query might be broken down into tokens like “Please,” “generate,” “a,” “what's,” “in,” “my,” “drinking,” “water,” “report,” “for,” “NYC,” “from,” “January,” “2018,” “February,” and “2018.” Based on these broken down tokens, the system can perform a semantic analysis of the tokens, resulting in a semantic meaning. This semantic meaning can have a high-dimensional space, meaning that the relationships between the words and how they contribute to the overall message/input can have many different dimensions. Such dimensions can vary as known to those of skill in the art. Non-limiting semantic dimensions can include: lexical semantics (the meaning of individual words and their relationships with other words), compositional semantics (how the meanings of individual words combine to form the meaning of larger structures like phrases and sentences), pragmatics/implications, denotation (the literal, dictionary definition of the word), connotation (the emotional/cultural meaning of the word), reference to real-world objects or concepts, relation to attitudes or feelings, etc. Next, the system generates an embedding, where each token is converted into a vector (embedding) that represents its semantic meaning in the high-dimensional space.

2) Contextual Understanding (Self-Attention): The system applies self-attention to these token embeddings to understand the relationships between the tokens. Self-attention is a mechanism within a transformer architecture that allows a model to weigh the importance of different parts of an input sequence when processing each part. This mechanism allows the model to focus on different parts of the input text and understand the context. Through self-attention, the system can determine that “NYC” refers to a location, “January 2018-February 2018” is a time range, and “drinking water report” refers to a specific type of document.

3) Processing through Transformer Layers: The token embeddings, now contextualized by self-attention, are passed through multiple layers of a transformer model. Each layer applies additional self-attention and feed-forward neural networks, refining the understanding of the input/query. Because transformers do not have a built-in sense of order, positional encodings are used to maintain the order of tokens in the sequence.

4) Query to Contextual Information: The system forms an internal representation of the query, which includes understanding the task (generating a report), the location (NYC), the time frame (January 2018-February 2018), and the specific focus (drinking water quality). Depending on a model's training, the system might retrieve relevant information from its knowledge base (e.g., statistical data, historical facts) or generate plausible data based on patterns it has learned.

5) Text Generation: The system (relying on the LLM) begins generating text by predicting the next token in the sequence, one at a time. It uses the internal representation of the query to guide the generation. For example, starting from an initial prompt (e.g., “Report on drinking water in NYC from January 2018-February 2018”), the model predicts the most likely next word, then the word after that, and so on. It uses the previously generated tokens to inform each subsequent prediction. At each step, the LLM generates a probability distribution over the entire vocabulary. The token with the highest probability is selected as the next word in the sequence.

6) Generating the Report Structure: The system will structure its output to resemble a report. It might include sections like “Introduction,” “Contaminants Detected,” “Concentrations and Compliance,” and “Conclusion.” For each section, the system generates content that aligns with what it learned during training. It might produce plausible data points (like contaminant levels) and explain them in context.

The report generation process operates in a manner distinct from how human beings analyze data. Whereas human beings consider words with a grammar, the system disclosed herein identifies the tokens and ranks their probability based on which tokens are next to one another. There is no explicit grammar, but instead an implicit grammar based on which tokens are side by side with one another.

7) Iterative Refinement (Beam Search, Sampling): The system (again relying on the model) might use techniques like beam search, where multiple possible sequences are considered, and the most coherent or contextually appropriate sequence is selected. If there's ambiguity in the query or if multiple valid outputs exist, the model might generate several versions and select the best one based on likelihood that a given sequence is correct/contextually appropriate.

8) Final Output: The generated tokens are combined to form complete sentences and paragraphs, which are then formatted into a coherent report. The text may undergo final post-processing steps to ensure proper grammar, coherence, and formatting before being presented as the final output.

Certain types of reports can require information that the user cannot provide. For example, a report associated with water quality may require verified information associated with a Hydrologic Unit Code (HUC). A HUC is a hierarchical land area classification system created by the United States Geological Survey (USGS) that is based on surface hydrologic features in a standard, uniform geographical framework. Once the system parses the query to identify a location of the HUC in question, the system can query databases (e.g., create one or more additional queries) containing HUC water quality data. Other information, such as but not limited to zip codes, latitude and longitude coordinates, Global Positioning System (GPS) coordinates, Universal Transverse Mercator (UTM) coordinates, etc., can be gathered via queries and/or generated based on the location with this step. While the new queries generated to obtain this verified data from verified sources will vary depending on a given top-level query, these new queries are based on the parameters extracted from the query as described above.

Once the verified data has been retrieved from the database, the system can use that verified data, in combination with generative AI, to build a report. To do this, the system supplies the parameters required to the generative AI to build the report.

In some configurations, the system may be configured to identify only report type (instead of a primary and secondary report type), or multiple report types (e.g., three or more). In addition, the system's architecture is robust and adaptable, allowing it to meet the needs of different industries and applications, whether in healthcare, finance, or environmental monitoring.

In some configurations, the system can automatically take mitigation measures based on the report and/or a user's instructions. For example, the system can, upon answering a user query and generating the report, automatically select a filter required to meet desired levels of water purity and deploy that filter. Such deployment could be within a water treatment plant, in the city/county water lines, or in a well, depending on how the filtration system is set up and connected with the system. Such filters can be selected based on meeting a minimum threshold, based on meeting a maximum purity of the water, based on removing a specified contaminant (e.g., when the contaminant is above a threshold level of toxicity), etc. Another exemplary mitigation measure which the system can take is to automatically send drones to take additional measurements and verify the accuracy of data, both presently and in the future as water/contaminants spread. Yet another exemplary mitigation measure can include releasing chemicals into the water supply to counteract detected contaminants.

As one non-limiting example of how the system disclosed herein improves the technical field of climate forecasting, the system herein allows a user to use a natural language query to ask a question, then parses the question and performs semantic/contextual analyses on the parsed question to identify what verified data sources can be resources to obtain data related to the question. The system then builds queries (again using the semantic/contextual analyses) for those respective, verified data sources and sends those queries out (e.g., over a network such as the Internet). Upon receiving responses, the system uses the received answers to the queries to build a report answering the user's question, and can (in some configurations) take real-world action to enact policies based on the predictions made in the report. Non-limiting examples of such features can include filtering water (e.g., inserting a physical filter, applying chemicals, rerouting water through a better filtration system, etc.), automatically assigning drones to perform future soil/water testing, increasing the height of a bridge or roadway based on a prediction, and/or automatically controlling gates/weirs/dams, etc.

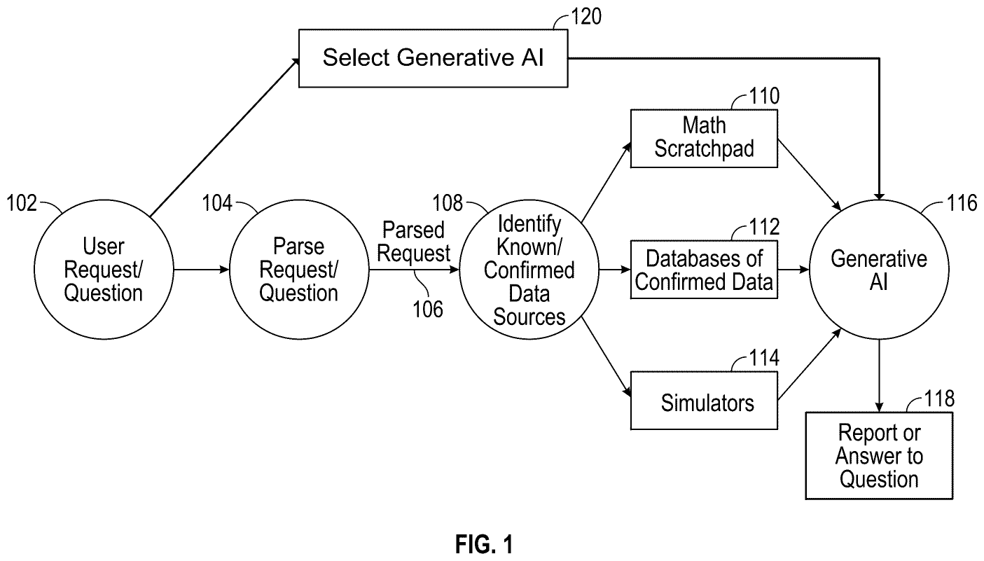

FIG. 1 illustrates an example system embodiment. In this example, the system receives a user request/question 102, then parses the request/question 104. The parsed request 106 is then used to identify known/confirmed data sources 108. In this example, the system identifies the needed known/confirmed data sources as a math scratchpad 110 (which allows the system to perform calculations), databases of confirmed data 112, and one or more simulators 114 (which can use data to predict future scenarios). The verified/known data from these known/confirmed sources 110, 112, 114 can then be used by a generative AI 116, with the output being a report or answer to the question 118. In some configurations, the system can have the option to select from among multiple generative AI options 120. For example, the system may be able to select between LLAMA, CHATGPT, GEMINI, etc. In other configurations, the system can train and use its own generative AI 116 (e.g., a proprietary generative AI), and the system can include the proprietary generative AI among the possible generative AI 116 options during the selection 120.

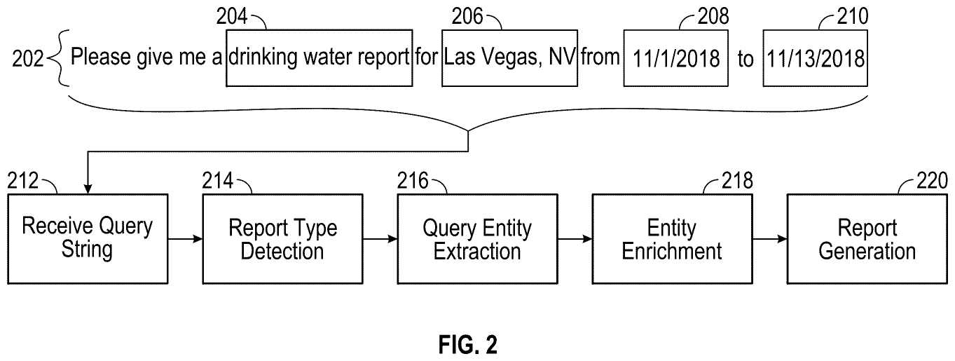

FIG. 2 illustrates an example of parsing a query 202. As used herein, parsing means to identify the different parts of the query 202 into their syntactic roles. As illustrated, the system parses the query 202 to perform a report type detection 214 to identify what type of result should be provided in response to the query 202. The system then extracts other query entities 216, performs entity enrichment 218, and generates a report 220. In this case, the system parses the query 202 to identify (1) “drinking water report” as a type of report/desired result; (2) “Las Vegas, NV” as a location; (3) “Nov. 1, 2018” as a start date; and (4) “Nov. 13, 2018” as an end date. In this example, the system would then locate verifiable information associated with the water reports of Las Vegas between Nov. 1, 2018 and Nov. 13, 2018, then use that verifiable information to generate the report 220.

Entity enrichment happens when the system correctly extracts an entity from the user query, but needs additional information to build the report.

Consider the following example: The user asks “What was the drinking water-quality of Washington D.C. on Jul. 4, 2024?, please build me a report”. The system then extracts from the query the required entities of

“city”: Washington DC,
“huc”: {“type”: “integer”},
“report_start_date”: 2024-06-04, # Date format as string
“report_end_date”: 2024-06-04, # Date format as string
“data_rich”: True, # Report type

In this example, the user does not provide what HUC they are in. Instead of asking the user to provide that HUC, the system is able to use the city (Washington DC) to find the HUC in a database, and then come back to the report generation step to give the user what they are looking for. In this case, DC belongs to HUC 8 (Subbasin): 02070010—Middle Potomac-Anacostia-Occoquan.

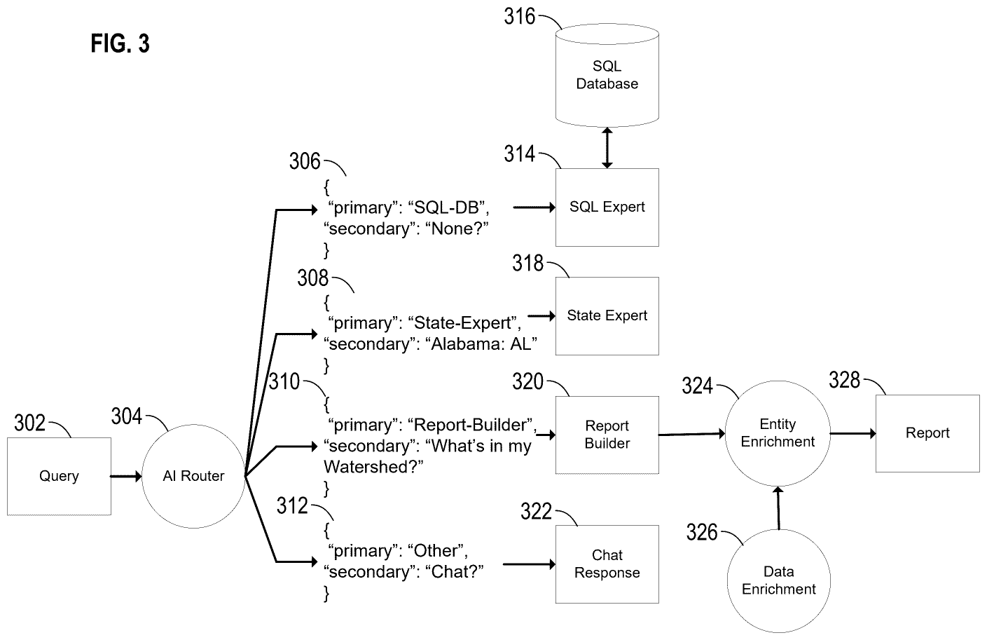

FIG. 3 illustrates a second example system embodiment. In this example, the system receives a query 302, and uses an AI router 304 to parse/analyze the query 302. The illustrated example shows four possible results from the processing done at the AI router 304. The AI router 304 can, for example, be a neural network configured to parse and/or analyze the query 302. In other configurations, the AI router 304 can use natural language processing to perform the parsing/analyzing of the query 302. The first result 306 has a primary report type of a “SQL-DB” and “none” for the secondary report type, such that the system deploys a SQL expert 314 to query/receive data from a SQL database 316. The second result 308 has a primary report type of “State-Expert” and “Alabama” for the secondary report type, resulting in the system deploying a state expert 318 (which may, in this case, be a database of Alabama specific information). The third result 310 has a primary report type of “Report-Builder” and a secondary report type of “What's in my watershed?”, such that the system deploys a report builder 320 tool, which may perform entity enrichment 324 (including data enrichment 326 on any of the data previously collected from the SQL expert 314 and/or the State Expert 318), and uses that enriched information to build a report 328. The fourth result 312 has a primary report type of “Other” and a secondary report type of “chat”, resulting in the system generating a chat response 322. In some configurations, the SQL expert 314 is used to answer questions that are in the database, and that information is not used to generate the report 328, but instead used to answer questions in the chat 322 interface. In such configurations, the chat does not play into a generated report 328.

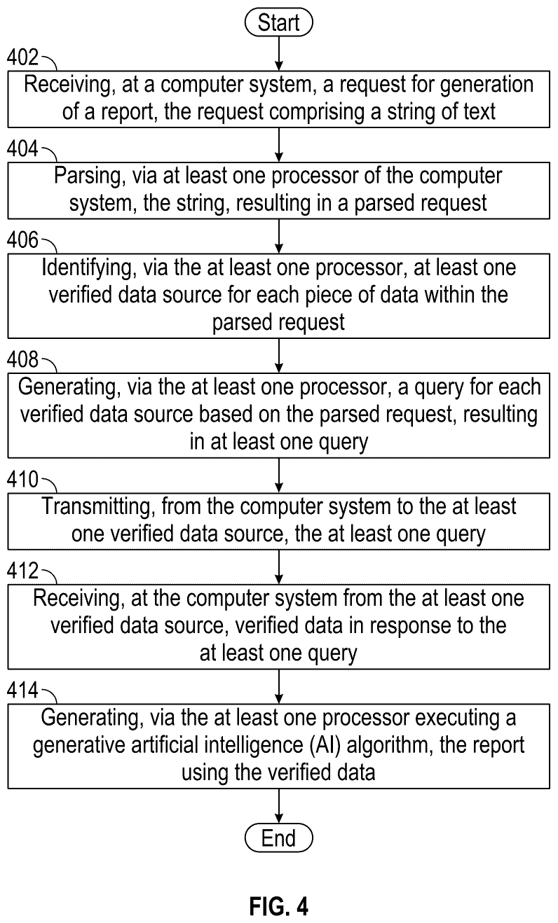

FIG. 4 illustrates an example method embodiment. As illustrated, the method can include receiving, at a computer system, a request for generation of a report, the request comprising a string of text (402) and parsing, via at least one processor of the computer system, the string, resulting in a parsed request (404). The method continues by identifying, via the at least one processor, at least one verified data source for each piece of data within the parsed request (406) and generating, via the at least one processor, a query for each verified data source based on the parsed request, resulting in at least one query (408). Next, the method can include transmitting, from the computer system to the at least one verified data source, the at least one query (410) and receiving, at the computer system from the at least one verified data source, verified data in response to the at least one query (412). The method then concludes with generating, via the at least one processor executing a generative Artificial Intelligence (AI) algorithm, the report using the verified data (414).

In some configurations, the report is associated with water for a designated location, and the at least one verified data source can include water-related data results for the designated location.

In some configurations, the at least one verified data source can include a mathematical scratchpad capable of executing mathematical calculations.

In some configurations, the illustrated method can further include: determining, via the at least one processor, a first report type and a second report type based on the parsed data, where the identifying of the at least one verified data source is based on the first report type and the second report type.

In some configurations, the request is a natural language query.

In some configurations, the illustrated method may include: transmitting at least one additional query to the at least one verified data source using at least one piece of verified data. In such configurations, the transmitting of the at least one additional query can continue until a predetermined level of accuracy is obtained.

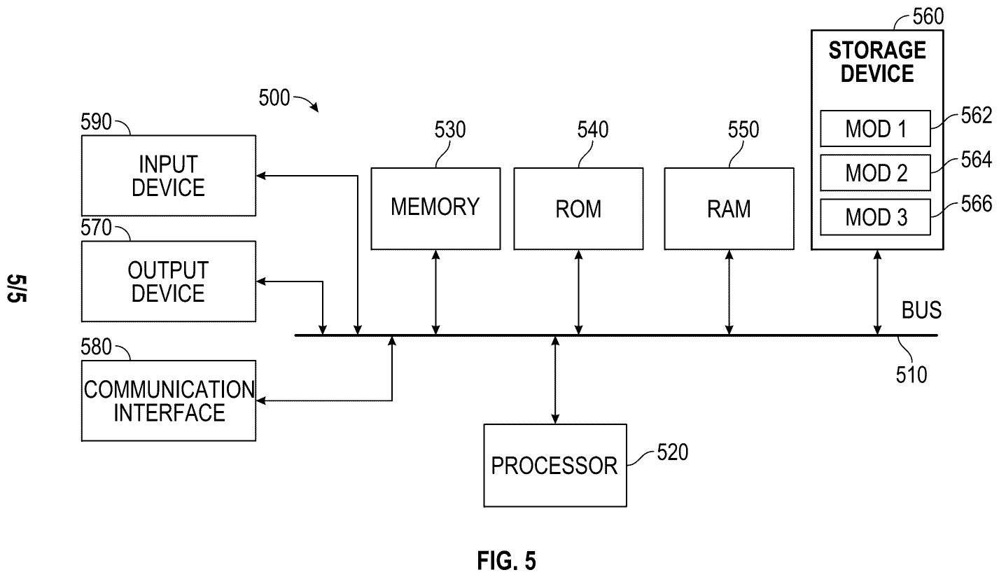

With reference to FIG. 5, an exemplary system includes a computing device 500 (such as a general-purpose computing device), including a processing unit (CPU or processor) 520 and a system bus 510 that couples various system components including the system memory 530 such as read-only memory (ROM) 540 and random access memory (RAM) 550 to the processor 520. The computing device 500 can include a cache of high-speed memory connected directly with, in close proximity to, or integrated as part of the processor 520. The computing device 500 copies data from the system memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The system memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general-purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in memory ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, system bus 510, output device 570 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 500 is a small, handheld computing device, a desktop computer, or a computer server.

Although the exemplary embodiment described herein employs the storage device 560 (such as a hard disk), other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per sc.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Neural networks, foundational to modern artificial intelligence, are computational systems designed to process data and generate predictions or classifications by emulating aspects of human brain function. A neural network is a framework of machine learning algorithms that work together to classify inputs based on a previous training process. They power applications like image recognition, natural language processing, and predictive analytics. At their core, neural networks consist of interconnected layers of mathematical units called neurons, organized into an input layer, one or more hidden layers, and an output layer. The input layer receives raw or preprocessed data, such as pixel values or text embeddings, represented as numerical vectors. Hidden layers transform this data into increasingly abstract representations through complex computations, while the output layer produces the result, such as a class probability or a numerical prediction. Each neuron connects to those in the next layer via weighted connections, where weights are numerical values that amplify or diminish the influence of one neuron's output on another's input. Additionally, biases-adjustable offsets enhance the model's flexibility in fitting data.

The operation of a neural network begins with a forward pass, where data flows from the input layer through the hidden layers to the output. Each neuron computes a weighted sum of its inputs, adds its bias, and applies a nonlinear activation function, such as a sigmoid, rectified linear unit (ReLU), or hyperbolic tangent (tanh), to produce an output. This process repeats across layers, with each layer extracting more complex features, such as edges in images or semantic patterns in text. The final layer's output depends on the task: classification tasks yield probabilities (e.g., “90%”), while regression tasks produce continuous values (e.g., a predicted temperature). Crucially, the forward pass does not alter the model's stored parameters-weights and biases-which represent the network's learned knowledge. These parameters are stored in digital memory, typically as 32-bit or 16-bit floating-point arrays. Weights form matrices, with rows and columns corresponding to neurons in adjacent layers, while biases are stored as one-dimensional arrays. Meta-information, such as layer counts and activation function types, is also stored to define the network's structure.

Training a neural network involves adjusting its parameters to minimize prediction errors. During training, a forward pass generates predictions, which are compared to correct outputs using a loss function, such as mean squared error or cross-entropy, to quantify errors. Backpropagation then computes gradients, indicating how much each parameter contributed to the error, by applying the chain rule to propagate errors backward from the output to the input layer. Optimization algorithms, like stochastic gradient descent, adjust weights and biases in directions that reduce the loss. This process iterates over multiple epochs, with parameters gradually converging to values that improve accuracy. Memory usage during training is dynamic: weights and biases are updated incrementally for each data batch, and intermediate results, like neuron activations and gradients, are temporarily stored in buffers to facilitate backpropagation. To ensure progress is saved, parameters are periodically checkpointed to persistent storage, allowing training to resume later. Efficiency techniques, such as reducing parameter precision to 16-bit formats, further optimize memory and computation.

Once trained, the network enters inference mode, where parameters are fixed, and only forward passes are executed to generate predictions. This mode minimizes memory writes, making it ideal for deployment on resource-constrained devices like mobile phones. Neural networks can provide storage architectures to reduce memory usage, unique parameter update mechanisms to enhance training efficiency, hybrid memory systems combining volatile and non-volatile storage, and/or dynamic precision adjustments during training or inference.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Consider the following case studies of how the system described herein has real-world practical impacts.

### Scenario #1: Emergency Water Crisis Management

Problem: A mid-sized city's water management department receives dozens of citizen complaints about discolored water and unusual taste over a weekend. The city manager needs to quickly determine if there's a widespread contamination issue, identify affected areas, understand potential health risks, and coordinate response efforts across multiple agencies. Traditional approaches would require weeks of manual data collection from various sources, lab testing coordination, and expert consultations from toxicologists, hydrologists, and public health officials.

Solution Implementation: The city's emergency response team uses the multi-agent AI system (i.e., the system disclosed herein) to rapidly assess the situation. A staff member enters a natural language query: “Generate comprehensive water quality assessment for downtown district from last 30 days, compare with historical baselines, identify contamination sources, and assess health risks.”

The system immediately:
Parses the query using Named Entity Recognition (NER) to identify “downtown district” (location), “last 30 days” (timeframe), and multiple report requirements
Deploys specialized AI agents that autonomously generate SQL queries to access:
   EPA's Toxics Release Inventory for nearby industrial facilities
   USGS live water sensor data for real-time flow rates and basic parameters
   Historical water quality databases for baseline comparisons
   State-specific regulatory compliance databases
   Consumer Confidence Reports from the water utility

The mathematical scratchpad agent then performs statistical analyses comparing current readings against 5-year historical averages, calculating standard deviations and identifying anomalies. The geospatial agent correlates contamination patterns with infrastructure maps, identifying that affected areas share common distribution pipes installed in 1978.

When the system encounters ambiguous toxicology data requiring expert interpretation, it automatically triggers a “human-in-the-loop” protocol, sending a video conference notification to the on-call toxicologist with specific data points flagged for review. The expert's feedback is immediately incorporated (e.g., the on-call toxicologist provides written feedback which is input into the system as an additional point of data analysis), and the system regenerates its risk assessment.

Results: The system produces a comprehensive report that would have taken a team of 10 experts at least 2 weeks to compile. The report includes:
Heat maps showing contamination spread patterns
Predictive models for next 48-hour contamination movement
Prioritized list of 3,200 affected households
Specific heavy metal concentrations with cited sources from verified databases
Recommended immediate actions based on EPA guidelines
Draft public health advisory with appropriate medical guidance

The city manager can then immediately activate targeted boil-water advisories, dispatch water testing teams to specific locations, and provide accurate information to healthcare providers about potential exposure risks. In some configurations, the system can automatically take mitigation measures based on the report and/or a user's instructions (such as the city manager in this example). For example, in this scenario the system may divert resources (e.g., change the flow of water in city pipes) to provide clean water at specific location, deploy filters into the city water system to remove specific contaminants, etc.

### Scenario #2: Agricultural Water Rights and Sustainability Planning

Problem: A large agricultural cooperative managing 50,000 acres needs to develop a comprehensive water sustainability plan for the next growing season while navigating complex water rights, anticipating drought conditions, optimizing crop selection, and ensuring regulatory compliance. The cooperative must balance water usage across 200+ member farms, each with different crops, soil conditions, and irrigation systems. Traditional consulting approaches would require hiring multiple firms specializing in hydrology, agricultural science, water law, and environmental compliance, costing millions and taking 6-8 months.

Solution Implementation: The cooperative's sustainability director uses the multi-agent system (i.e., the system disclosed herein) with a complex multi-part query: “Generate integrated water management plan for a County agricultural zone, incorporating 5-year drought projections, optimize for almond and grape production, ensure compliance with SGMA (Sustainable Groundwater Management Act) requirements, and identify water trading opportunities.”

The system's multi-agent architecture springs into action:
A legal compliance agent within the system accesses Sustainable Groundwater Management Act (SGMA) databases and water rights registries.
A climate prediction agent within the system queries NOAA databases and processes historical precipitation data through the mathematical scratchpad.
An agricultural optimization agent within the system analyzes soil composition data, crop water requirements, and market price projections.
A water trading agent within the system identifies surplus water rights from neighboring districts.

These agents can act simultaneously, as described above.

The system then performs entity enrichment by automatically determining that “[the county's] agricultural zone” encompasses 12 different Hydrologic Unit Codes (HUCs), retrieving specific groundwater basin data for each. The system generates SQL queries to pull 10 years of groundwater level measurements, correlating them with crop yield data.

When the system identifies potential conflicts between water allocations and endangered species habitat requirements, it initiates human-in-the-loop validation with the cooperative's environmental compliance officer. The officer provides clarification on mitigation measures, which the system incorporates into its recommendations.

Results: The system delivers a 200-page dynamic report in 4 hours that includes:
Optimized water allocation schedules for each member farm
Crop rotation recommendations that reduce water usage by 23% while maintaining profitability
Identification of 15 potential water trading partners with compatible timing needs
Predictive models showing groundwater recharge rates under different irrigation scenarios
Compliance checklist with 47 specific SGMA requirements and current status
Risk assessment matrix for drought scenarios with contingency plans
An interactive dashboard allowing real-time adjustments based on weather changes

The cooperative saves $2.3 million in consulting fees, reduces planning time from 6 months to 1 week, and achieves a more sophisticated, data-driven plan than traditional methods could provide. The dynamic nature of the system allows for continuous updates as conditions change, something impossible with traditional static consulting reports. In some configurations, the system can automatically take measures based on the report and/or a user. In this example, such measures could include, if the water systems are electronically controlled, automatically controlling gates/weirs/dams etc. according to the optimized water allocation schedules.

### Scenario #3: Industrial Perfluoroalkyl and Polyfluoroalkyl Substances (PFAS) Contamination Investigation and Remediation Planning

Problem: A state environmental protection agency receives reports of elevated PFAS (per- and polyfluoroalkyl substances) levels in drinking water wells near a former aerospace manufacturing facility. The agency must rapidly investigate the contamination plume, identify all affected water systems (both public and private), trace the contamination source, assess health risks for 75,000 residents, coordinate with multiple federal databases, and develop a comprehensive remediation plan. Traditional investigation methods would require coordinating between hydrogeologists, toxicologists, Geographic Information System (GIS) specialists, regulatory experts, and public health officials, taking 4-6 months for initial assessment alone. The complexity is compounded by PFAS being an emerging contaminant with evolving regulations, multiple chemical variants, and data scattered across federal (e.g., the Environmental Protection Agency (EPA)), state, and local databases.

Solution Implementation: The state's environmental emergency response team deploys the multi-agent AI system (i.e., the system disclosed herein) with a complex investigative query: “Map PFAS contamination plume for 10-mile radius around [a specifically named] facility, identify all affected water sources, trace historical discharge patterns from 1960-present, assess population exposure risks, and generate remediation options with cost estimates.”

The system's sophisticated multi-agent orchestration begins:

### Phase 1—Historical Investigation:

The system simultaneously:
Generates SQL queries to access EPA's Facility Registry System, pulling 60 years of operational permits;
Queries the Toxics Release Inventory for historical chemical discharge reports; and
Accesses state archives for digitized inspection reports and violations.

A pattern recognition agent within the system identifies that the facility switched from PFOS to perfluorooctanoic acid (PFOA) compounds in 1987, then to GenX chemicals (i.e., one of many synthetic organofluorine compounds collectively known as PFASs) in 2009

### Phase 2—Contamination Mapping:

A hydrogeological agent within the system accesses United States Geological Survey (USGS) groundwater flow models for the region;
The system generates queries for all water quality tests within the affected Hydrologic Unit Codes (HUCs) over the past 20 years;
The mathematical scratchpad performs complex plume migration calculations using Darcy's Law and advection-dispersion equations; and
Identifies 47 private wells, 12 public water systems, and 3 schools with dedicated wells in the contamination pathway.

Phase 3—Entity Enrichment and Data Fusion: The system recognizes it needs additional data not explicitly requested:
Automatically retrieves soil composition data to refine contamination transport models;
Queries precipitation databases to understand seasonal variation in plume movement;
Accesses property records to identify well ownership and usage patterns; and
Cross-references with CDC health databases for cancer cluster analysis.

Phase 4—Human-in-the-Loop Validation: When the system encounters conflicting data between state and federal PFAS standards (federal Maximum Contaminant Level (MCL) of 4 ppt vs. state guideline of 20 ppt), it triggers human review:
The system sends video-conference notification to the agency's chief toxicologist;
Presents both standards with scientific justification for each;
Toxicologist selects the more stringent federal standard; and
System regenerates risk assessments using the 4 ppt threshold.

### Phase 5—Predictive Modeling and Remediation Planning:

A remediation agent of the system queries databases of successful PFAS treatment technologies;
The system generates cost estimates using historical project data from similar sites;
Models contamination spread under various remediation scenarios; and
Predicts 10-year migration patterns with and without intervention.

Results: The system produces a comprehensive investigation and action plan in 72 hours that includes:
Technical Findings:
   3D visualization of the contamination plume showing concentration gradients from 2,400 ppt at the source to 4 ppt at the periphery
   Time-lapse animation showing plume evolution from 1960 to present
   Identification of 3 previously unknown hot spots from historical spills in 1973, 1991, and 2008.
   Chemical fingerprinting showing transition from legacy PFAS to newer compounds
   Groundwater flow analysis revealing contamination will reach the municipal water intake in 18 months without intervention
A Public Health Assessment:
   Risk-stratified list of 8,400 affected residents based on exposure duration and concentration
   Specific health screening recommendations for 6 different PFAS compounds detected
   Vulnerability analysis highlighting 2 daycare centers and 1 senior living facility in high-exposure zones
   Biomonitoring protocol for residents with private wells exceeding 40 ppt
A Remediation Strategy:
   Prioritized action plan with 5 phases over 36 months
   Comparison of 4 treatment technologies (Granular Active Carbon (GAC), ion exchange, reverse osmosis, foam fractionation) with site-specific effectiveness ratings
   Cost-benefit analysis ranging from $12M emergency response to $145M full remediation
   Identification of 3 federal funding sources totaling $67M in available grants
   Natural attenuation modeling showing 200-year persistence without intervention
A Regulatory Compliance Package:
   Pre-filled EPA reporting forms with all required data points
   Draft consent decree with responsible party including specific milestones
   Public notification templates compliant with Safe Drinking Water Act requirements
A Documentation package for cost recovery litigation with cited precedents

The system in this scenario demonstrates several capabilities impossible with traditional methods:
Automatically identified and retrieved data from 23 different databases without manual programming
Performed complex hydrogeological modeling that would require specialized software and expertise
Synthesized 60 years of historical data to reconstruct contamination timeline
Generated legally-defensible documentation with complete citation chains
Adapted to emerging contaminant challenges where regulations and science are rapidly evolving

The state agency reduces investigation time from 6 months to 3 days, saves $1.8M in consultant fees, and most critically, accelerates public health interventions by months, potentially preventing hundreds of additional exposure cases. The dynamic nature of the system allows for real-time updates as new PFAS research emerges or regulations change, maintaining relevance in a rapidly evolving field.

In some configurations, the system can automatically take mitigation measures based on the report and/or a user's instructions. In this example, exemplary mitigation measures which can be deployed by the system can include: automatically deploying filters selected to remove one or more of the chemicals detected within a given zone (e.g., at a water treatment plant, or within the water lines), automatically assign drones to perform future soil/water testing, etc.

Further aspects of the present disclosure are provided by the subject matter of the following clauses.

A method comprising: receiving, at a computer system, a request for generation of a report, the request comprising a string of text. The string of text can be received, for example, via a user interface (UI) including one or more of a keyboard, touch-screen, microphone with a speech-to-text conversion algorithm, etc. The method continues by parsing, via at least one processor of the computer system, the string, resulting in a parsed request. Parsing, in this context, refers to the process of analyzing a string of characters (text) to extract meaningful information and convert it into a more structured or usable format. This process typically involves breaking down the string into its constituent parts, often referred to as “tokens,” and then interpreting the relationships between these tokens based on a defined set of rules or grammar. During the parsing process, primary and secondary categories/types of data associated with each part/token can be assigned. Next, the method includes identifying, via the at least one processor, at least one verified data source for each piece of data within the parsed request. Verified in this context, refers to known, trustworthy, non-hallucinated data sources. The identification process, as described above, can use the parsed data to identify which of the verified data sources known to the system has the ability to retrieve or process each respective piece of data identified during the parsing. Such identification can be based, for example, on the type of data, the level of similarity of the data, the primary/secondary types of data assigned during the parsing, etc.

Next, the method can include generating, via the at least one processor, a query for each verified data source based on the parsed request, resulting in at least one query. This can include, for example, constructing a string query to be used to look up data in a database, to process information, to ask for additional details from the user, etc. Construction of the query can, in some cases, make use of a large language model (e.g., a Generative Pre-trained Transformer, GPT), with the large language model providing string characters needed to form the query around the specific terms identified, in a format which meets the requirements for a given query's intended destination. Next, the method can include transmitting, from the computer system to the at least one verified data source, the at least one query. This can include a wireless communication (e.g., radio frequency, BLUETOOTH transmission, Wi-Fi, a wired communication (e.g., networked, Internet-based, telephonic, etc.), and the mechanisms required to make that transmission possible. The method next includes receiving, at the computer system from the at least one verified data source, verified data in response to the at least one query, and generating, via the at least one processor executing a generative Artificial Intelligence (AI) algorithm, the report using the verified data. The generative AI algorithm can again be a GPT or other neural network. In some configurations, this AI algorithm can be trained using training data designed to combine various types of data, from one or more “expert” algorithms (as defined above), into a neural network (i.e., the AI algorithm).

The method of any preceding clause, wherein the report is associated with water for a designated location; and wherein the at least one verified data source comprises water-related data results for the designated location.

The method of any preceding clause, wherein the at least one verified data source comprises a mathematical scratchpad capable of executing mathematical calculations.

The method of any preceding clause, further comprising: determining, via the at least one processor, a first report type and a second report type based on the parsed request, wherein the identifying of the at least one verified data source is based on the first report type and the second report type.

The method of any preceding clause, wherein the request is a natural language query.

The method of any preceding clause, further comprising: transmitting at least one additional query to the at least one verified data source using at least one piece of verified data.

The method of any preceding clause, wherein the transmitting of the at least one additional query continues until a predetermined level of accuracy is obtained.

A system comprising: at least one processor; and a non-transitory computer-readable storage medium having instructions stored which, when executed by the at least one processor, cause the at least one processor to perform operations comprising: receiving a request for generation of a report, the request comprising a string of text; parsing the string, resulting in a parsed request; identifying at least one verified data source for each piece of data within the parsed request; generating a query for each verified data source based on the parsed request, resulting in at least one query; transmitting to the at least one verified data source the at least one query; receiving, from the at least one verified data source, verified data in response to the at least one query; and generating, by executing a generative Artificial Intelligence (AI) algorithm, the report using the verified data.

The system of any preceding clause, wherein the report is associated with water for a designated location; and wherein the at least one verified data source comprises water-related data results for the designated location.

The system of any preceding clause, wherein the at least one verified data source comprises a mathematical scratchpad capable of executing mathematical calculations.

The system of any preceding clause, the non-transitory computer-readable storage medium having additional instructions stored which, when executed by the at least one processor, cause the at least one processor to perform operations comprising: determining a first report type and a second report type based on the parsed request, wherein the identifying of the at least one verified data source is based on the first report type and the second report type.

The system of any preceding clause, wherein the request is a natural language query.

The system of any preceding clause, the non-transitory computer-readable storage medium having additional instructions stored which, when executed by the at least one processor, cause the at least one processor to perform operations comprising: transmitting at least one additional query to the at least one verified data source using at least one piece of verified data.

The system of any preceding clause, wherein the transmitting of the at least one additional query continues until a predetermined level of accuracy is obtained.

A non-transitory computer-readable storage medium having instructions stored which, when executed by at least one processor, cause the at least one processor to perform operations comprising: receiving a request for generation of a report, the request comprising a string of text; parsing the string, resulting in a parsed request; identifying at least one verified data source for each piece of data within the parsed request; generating a query for each verified data source based on the parsed request, resulting in at least one query; transmitting to the at least one verified data source the at least one query; receiving, from the at least one verified data source, verified data in response to the at least one query; and generating, by executing a generative Artificial Intelligence (AI) algorithm, the report using the verified data.

The non-transitory computer-readable storage medium of any preceding clause, wherein the report is associated with water for a designated location; and wherein the at least one verified data source comprises water-related data results for the designated location.

The non-transitory computer-readable storage medium of any preceding clause, wherein the at least one verified data source comprises a mathematical scratchpad capable of executing mathematical calculations.

The non-transitory computer-readable storage medium of any preceding clause, the non-transitory computer-readable storage medium having additional instructions stored which, when executed by the at least one processor, cause the at least one processor to perform operations comprising: determining a first report type and a second report type based on the parsed request, wherein the identifying of the at least one verified data source is based on the first report type and the second report type.

The non-transitory computer-readable storage medium of any preceding clause, wherein the request is a natural language query.

The non-transitory computer-readable storage medium of any preceding clause, the non-transitory computer-readable storage medium having additional instructions stored which, when executed by the at least one processor, cause the at least one processor to perform operations comprising: transmitting at least one additional query to the at least one verified data source using at least one piece of verified data.

We claim:

1. A method comprising:
receiving, at a computer system, a request for generation of a report, the request comprising a string of text;
parsing, via at least one processor of the computer system, the string, resulting in a parsed request;
identifying, via the at least one processor, at least one verified data source for each piece of data within the parsed request;
generating, via the at least one processor, a query for each verified data source based on the parsed request, resulting in at least one query;
transmitting, from the computer system to the at least one verified data source, the at least one query;
receiving, at the computer system from the at least one verified data source, verified data in response to the at least one query; and
generating, via the at least one processor executing a generative Artificial Intelligence (AI) algorithm, the report using the verified data.

2. The method of claim 1, wherein the report is associated with water for a designated location; and
wherein the at least one verified data source comprises water-related data results for the designated location.

3. The method of claim 1, wherein the at least one verified data source comprises a mathematical scratchpad capable of executing mathematical calculations.

4. The method of claim 1, further comprising:
determining, via the at least one processor, a first report type and a second report type based on the parsed request,
wherein the identifying of the at least one verified data source is based on the first report type and the second report type.

5. The method of claim 1, wherein the request is a natural language query.

6. The method of claim 1, further comprising:
transmitting at least one additional query to the at least one verified data source using at least one piece of verified data.

7. The method of claim 6, wherein the transmitting of the at least one additional query continues until a predetermined level of accuracy is obtained.

8. A system comprising:
at least one processor; and
a non-transitory computer-readable storage medium having instructions stored which, when executed by the at least one processor, cause the at least one processor to perform operations comprising:
receiving a request for generation of a report, the request comprising a string of text;
parsing the string, resulting in a parsed request;
identifying at least one verified data source for each piece of data within the parsed request;
generating a query for each verified data source based on the parsed request, resulting in at least one query;
transmitting to the at least one verified data source the at least one query;
receiving, from the at least one verified data source, verified data in response to the at least one query; and
generating, by executing a generative Artificial Intelligence (AI) algorithm, the report using the verified data.

9. The system of claim 8, wherein the report is associated with water for a designated location; and
wherein the at least one verified data source comprises water-related data results for the designated location.

10. The system of claim 8, wherein the at least one verified data source comprises a mathematical scratchpad capable of executing mathematical calculations.

11. The system of claim 8, the non-transitory computer-readable storage medium having additional instructions stored which, when executed by the at least one processor, cause the at least one processor to perform operations comprising:
determining a first report type and a second report type based on the parsed request,
wherein the identifying of the at least one verified data source is based on the first report type and the second report type.

12. The system of claim 8, wherein the request is a natural language query.

13. The system of claim 8, the non-transitory computer-readable storage medium having additional instructions stored which, when executed by the at least one processor, cause the at least one processor to perform operations comprising:
transmitting at least one additional query to the at least one verified data source using at least one piece of verified data.

14. The system of claim 13, wherein the transmitting of the at least one additional query continues until a predetermined level of accuracy is obtained.

15. A non-transitory computer-readable storage medium having instructions stored which, when executed by at least one processor, cause the at least one processor to perform operations comprising:
receiving a request for generation of a report, the request comprising a string of text;
parsing the string, resulting in a parsed request;
identifying at least one verified data source for each piece of data within the parsed request;
generating a query for each verified data source based on the parsed request, resulting in at least one query;
transmitting to the at least one verified data source the at least one query;
receiving, from the at least one verified data source, verified data in response to the at least one query; and
generating, by executing a generative Artificial Intelligence (AI) algorithm, the report using the verified data.

16. The non-transitory computer-readable storage medium of claim 15, wherein the report is associated with water for a designated location; and
wherein the at least one verified data source comprises water-related data results for the designated location.

17. The non-transitory computer-readable storage medium of claim 15, wherein the at least one verified data source comprises a mathematical scratchpad capable of executing mathematical calculations.

18. The non-transitory computer-readable storage medium of claim 15, the non-transitory computer-readable storage medium having additional instructions stored which, when executed by the at least one processor, cause the at least one processor to perform operations comprising:
determining a first report type and a second report type based on the parsed request,
wherein the identifying of the at least one verified data source is based on the first report type and the second report type.

19. The non-transitory computer-readable storage medium of claim 15, wherein the request is a natural language query.

20. The non-transitory computer-readable storage medium of claim 15, the non-transitory computer-readable storage medium having additional instructions stored which, when executed by the at least one processor, cause the at least one processor to perform operations comprising:
transmitting at least one additional query to the at least one verified data source using at least one piece of verified data.
